(19) United States
(12) Patent Application Publication
(10) Pub. No.: US 2019/0362628 A1
(43) Pub. Date: Nov. 28, 2019

(54) TRAVEL ASSISTANCE DEVICE, TRAVEL ASSISTANCE METHOD, AND COMPUTER PROGRAM

(71) Applicants: AutoNetworks Technologies, Ltd., Yokkaichi (JP); Sumitomo Wiring Systems, Ltd., Yokkaichi (JP); Sumitomo Electric Industries, Ltd., Osaka-Shi (JP)

(72) Inventors: Tadashi Matsumoto, Yokkaichi (JP); Takeshi Hagihara, Yokkaichi (JP); Yuichi Kodama, Yokkaichi (JP); Yasuhiro Yabuuchi, Yokkaichi (JP)

(21) Appl. No.: 16/413,137

(22) Filed: May 15, 2019

(30) Foreign Application Priority Data
May 24, 2018 (JP) 2018-099907

(51) Int. Cl. G08G 1/0967

(52) U.S. Cl. CPC G08G 1/096783

(57) ABSTRACT

A travel assistance device, a travel assistance method, and a computer program are provided. A travel assistance device to be mounted in a vehicle includes: an in-vehicle communication unit to which information received from a road-side communicator is input; and an output unit configured to, if both intersection information including an identifier identifying an intersection and position information regarding the intersection and traffic signal information including the same identifier are input from the in-vehicle communication unit, output travel assistance information that is based on the traffic signal information.

### CROSS-REFERENCE TO RELATED APPLICATIONS

This application claims priority of Japanese Patent Application No. JP 2018-099907 filed May 24, 2018, the contents of which are incorporated herein.

### TECHNICAL FIELD

The present disclosure relates to a travel assistance device, a travel assistance method, and a computer program.

### BACKGROUND

In recent years, travel assistance systems have been put into practical use to assist the traveling of vehicles by transmitting, to the vehicles, information regarding intersections and information regarding traffic signals installed at intersections from road-side communicators that are installed near intersections.

JP 2010-170322A is an example of related art.

There are cases where radio waves in a specific frequency band (e.g. 5.9 GHz band) are used in wireless communication between a road-side communicator and an in-vehicle communication device mounted in a vehicle. Wireless communication using radio waves has characteristics of weak directivity and a wide communication area compared with infrared communication using near-infrared light. For this reason, there is possibility that an in-vehicle communication device receives not only information transmitted from the road-side communicator that is closest to the vehicle but also information transmitted from a road-side communicator that is installed farther away. If travel assistance is performed for the vehicle based on the information from the road-side communicator that is installed farther away, travel assistance is performed based not on information regarding a traffic signal installed at an intersection through which the vehicle is about to pass but on information regarding a traffic signal installed at another intersection, resulting in the user being confused.

The present disclosure has been made in view of the foregoing situation, and aims to provide a travel assistance device, a travel assistance method, and a computer program that are capable of avoiding travel assistance being performed, when a vehicle passes through an intersection, based on traffic signal information regarding a traffic signal installed at another intersection.

### SUMMARY

A travel assistance device according to an aspect of the present application is a travel assistance device to be mounted in a vehicle, the device including: an in-vehicle communication unit to which information received from a road-side communicator is input; and an output unit configured to, if both intersection information including an identifier identifying an intersection and position information regarding the intersection and traffic signal information including the same identifier are input from the in-vehicle communication unit, output travel assistance information that is based on the traffic signal information.

A travel assistance method according to an aspect of the present application is a travel assistance method for assisting traveling of a vehicle, the method including: outputting travel assistance information that is based on traffic signal information if both intersection information including an identifier identifying an intersection and position information regarding the intersection and the traffic signal information including the same identifier are input.

A computer program according to an aspect of the present application is a computer program for causing a computer mounted in a vehicle to perform processing for: outputting travel assistance information that is based on traffic signal information if both intersection information including an identifier identifying an intersection and position information regarding the intersection and the traffic signal information including the same identifier are input.

According to the present application, when a vehicle passes through an intersection, it is possible to avoid travel assistance being performed based on traffic signal information regarding a traffic signal installed at another intersection.

### BRIEF DESCRIPTION OF THE DRAWINGS

FIG. 1 is a schematic diagram showing a schematic configuration of a travel assistance system according to the present embodiment.

FIG. 2 is a block diagram illustrating an internal configuration of an in-vehicle device.

FIG. 3 is a conceptual diagram illustrating a configuration example of intersection information.

FIG. 4 is a conceptual diagram illustrating a configuration example of traffic signal information.

FIG. 5 is a flowchart illustrating a processing procedure performed by the in-vehicle device according to Embodiment 1.

FIG. 6 is a schematic diagram showing a display example of a recommended speed.

FIG. 7 is a schematic diagram showing a display example in a stopped state.

FIG. 8 is a schematic diagram showing a display example when turning right.

FIG. 9 is a flowchart illustrating a processing procedure performed by the in-vehicle device according to Embodiment 2.

FIG. 10 is a flowchart illustrating a processing procedure performed by the in-vehicle device according to Embodiment 3.

FIG. 11 is a flowchart illustrating a processing procedure performed by the in-vehicle device according to Embodiment 4.

### DETAILED DESCRIPTION OF PREFERRED EMBODIMENTS

Aspects of the present disclosure will be described below. At least some of the following aspects may also be combined in any manner.

A travel assistance device according to an aspect of the present application is a travel assistance device to be mounted in a vehicle, the device including: an in-vehicle communication unit to which information received from a road-side communicator is input; and an output unit configured to, if both intersection information including an identifier identifying an intersection and position information regarding the intersection and traffic signal information including the same identifier are input from the in-vehicle communication unit, output travel assistance information that is based on the traffic signal information.

According to the above aspect, if the identifier of an intersection included in intersection information matches the identifier of an intersection included in traffic signal information, travel assistance information that is based on the traffic signal information is output, and thus, travel assistance can be performed for the driver of the vehicle. On the other hand, if traffic signal information is received at a timing at which intersection information with a matched identifier has not been received, travel assistance information that is based on this traffic signal information is not output. Accordingly, when the vehicle passes through an intersection, travel assistance being performed based on traffic signal information regarding a traffic signal installed at another intersection is avoided.

The travel assistance device according to an aspect of the present application further includes a determination unit configured to, if position information regarding the vehicle is input from the in-vehicle communication unit, specify a positional relationship between the vehicle and an intersection based on the position information regarding the vehicle and the intersection information, and determine, based on the specified positional relationship, whether or not to allow the travel assistance information to be output, wherein the output unit outputs the travel assistance information if the determination unit determines that the travel assistance information is allowed to be output.

According to the above aspect, whether or not to allow travel assistance information to be output is determined based on the positional relationship between the vehicle and each intersection. Accordingly, when the vehicle passes through an intersection, even if traffic signal information regarding a traffic signal installed at another intersection is received, control can be performed such that travel assistance information that is based on this traffic signal information is not output.

In the travel assistance device according to an aspect of the present application, if a plurality of pieces of intersection information are input from the in-vehicle communication unit, the determination unit determines whether or not a second intersection is present between a first intersection and the vehicle, and if it is determined that the second intersection is present, the determination unit determines that the travel assistance information that is based on traffic signal information including the same identifier as an identifier of the first intersection is not allowed to be output.

According to the above aspect, if the second intersection is present between the first intersection and the vehicle, travel assistance is not performed based on traffic signal information regarding a traffic signal installed at the first intersection. Accordingly, when the vehicle passes through an intersection, travel assistance being performed based on traffic signal information regarding a traffic signal installed at another intersection is avoided.

In the travel assistance device according to an aspect of the present application, if a plurality of pieces of intersection information are input from the in-vehicle communication unit, the determination unit specifies an intersection that is closest to the vehicle, and determines that travel assistance information that is based on traffic signal information including an identifier different from an identifier of the specified intersection is not allowed to be output.

According to the above aspect, if traffic signal information is received regarding a traffic signal installed at an intersection other than the intersection that is closest to the vehicle, travel assistance is not performed based on this traffic signal information. Accordingly, when the vehicle passes through an intersection, travel assistance being performed based on traffic signal information regarding a traffic signal installed at another intersection is avoided.

In the travel assistance device according to an aspect of the present application, if an intersection identified by the intersection information is not present in a direction in which the vehicle proceeds, the determination unit determines that travel assistance information that is based on traffic signal information including the same identifier as an identifier of the intersection is not allowed to be output.

According to the above aspect, if traffic signal information is received regarding a traffic signal installed at an intersection that is not present in the direction in which the vehicle proceeds, travel assistance is not performed based on this traffic signal information. Accordingly, when the vehicle passes through an intersection, travel assistance being performed based on traffic signal information regarding a traffic signal installed at another intersection is avoided.

The travel assistance device according to an aspect of the present application further includes: a storage unit configured to store intersection information input from the in-vehicle communication unit; and an erasing unit configured to erase, from the storage unit, intersection information regarding an intersection that is not present in a direction in which the vehicle proceeds, out of the intersection information stored in the storage unit.

According to the above aspect, intersection information regarding an intersection that is not present in the direction in which the vehicle proceeds is erased. Accordingly, even if traffic signal information regarding a traffic signal installed at this intersection is received, no identifier in intersection information matches the identifier in the traffic signal information, and travel assistance that is based on the traffic signal is avoided.

A travel assistance method according to an aspect of the present application is a travel assistance method for assisting traveling of a vehicle, the method including: outputting travel assistance information that is based on traffic signal information if both intersection information including an identifier identifying an intersection and position information regarding the intersection and the traffic signal information including the same identifier are input.

According to the above aspect, if the identifier of an intersection included in intersection information matches the identifier of an intersection included in traffic signal information, travel assistance information that is based on the traffic signal information is output, and thus, travel assistance can be performed for the driver of the vehicle. On the other hand, if traffic signal information is received at a timing at which intersection information with a matched identifier has not been received, travel assistance information that is based on this traffic signal information is not output. Accordingly, when the vehicle passes through an intersection, travel assistance being performed based on traffic signal information regarding a traffic signal installed at another intersection is avoided.

A computer program according to an aspect of the present application is a computer program for causing a computer mounted in a vehicle to perform processing for: outputting travel assistance information that is based on traffic signal information if both intersection information including an identifier identifying an intersection and position information regarding the intersection and the traffic signal information including the same identifier are input.

According to the above aspect, if the identifier of an intersection included in intersection information matches the identifier of an intersection included in traffic signal information, travel assistance information that is based on the traffic signal information is output, and thus, travel assistance can be performed for the driver of the vehicle. On the other hand, if traffic signal information is received at a timing at which intersection information with a matched identifier has not been received, travel assistance information that is based on this traffic signal information is not output. Accordingly, when the vehicle passes through an intersection, travel assistance being performed based on traffic signal information regarding a traffic signal installed at another intersection is avoided.

Hereinafter, the present disclosure will be described in detail based on the drawings showing an embodiment thereof.

### Embodiment 1

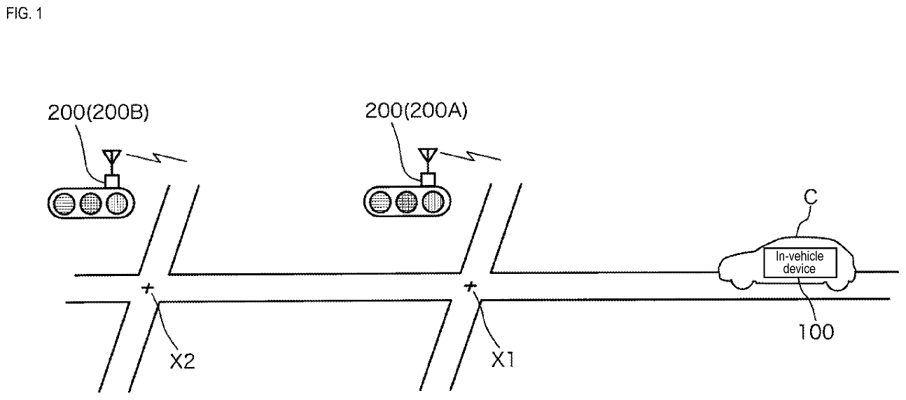

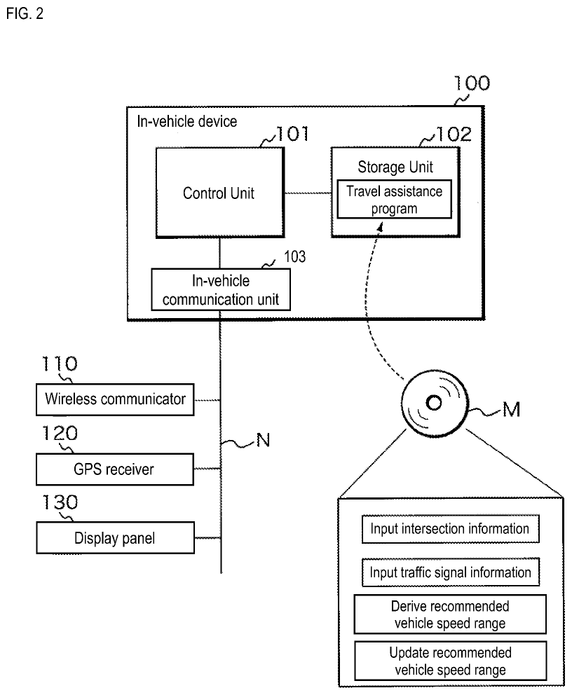

FIG. 1 is a schematic diagram showing a schematic configuration of a travel assistance system according to the present embodiment. The travel assistance system according to this embodiment includes an in-vehicle device 100 (see FIG. 2), which is mounted in a vehicle C, and road-side communicators 200, which are installed on a road. The in-vehicle device 100 receives various kinds of information transmitted from the road-side communicators 200, and outputs information related to travel assistance for the vehicle C based on the received information.

Each of the road-side communicators 200 is installed near an intersection, for example, and regularly and repeatedly transmits intersection information, which includes information regarding the position of the intersection, traffic signal information, which includes information regarding color change in the traffic signal installed at the intersection, and so on. According to a message standard used in the North American DSRC (Dedicated Short Range Communication), MAP (Map Data) corresponds to the intersection information, and SPaT (Signal Phase and Timing) corresponds to the traffic signal information.

Note that not all of the road-side communicators 200 in the system need to transmit both the intersection information and the signal information, and the system may include a road-side communicator 200 that does not transmit the traffic signal information but only transmits the intersection information.

Radio waves that pertain to a 5.9 GHz transmission band, for example, are used in wireless communication between the in-vehicle device 100 and the road-side communicators 200. Wireless communication using radio waves that pertain to such a transmission band has characteristics of weak directivity and a wide communication area compared with infrared communication using light beacons. For this reason, there is a possibility that the in-vehicle device 100 not only receives information transmitted from a road-side communicator 200 (200A) installed near an intersection X1 that is closest to the vehicle C, but also receives information transmitted from a road-side communicator 200 (200B) installed near an intersection X2 that is located farther away.

For example, in the case of a configuration in which the road-side communicator 200A only transmits intersection information, and the road-side communicator 200B transmits both intersection information and traffic signal information, there is a possibility that the in-vehicle device 100 receives the intersection information from the road-side communicator 200A and also receives intersection information and the traffic signal information from the road-side communicator 200B, depending on the positional relationship between the vehicle C and the road-side communicators 200A and 200B. In this case, there is a possibility that the in-vehicle device 100 provides the driver of the vehicle C that is about to proceed to an intersection X1 with travel assistance information that is based on traffic signal information regarding a traffic signal installed near an intersection X2, which may confuse the driver.

In this embodiment, an identifier of an intersection (intersection ID) included in intersection information received by the in-vehicle device 100 is compared with an identifier of an intersection (intersection ID) included in received traffic signal information, and travel assistance information is output only if these identifiers match, thereby avoiding information that may confuse the driver from being output.

FIG. 2 is a block diagram illustrating an internal configuration of the in-vehicle device 100. The in-vehicle device 100 is an ECU (Electronic Control Unit) for controlling equipment in the vehicle C, for example, and includes a control unit 101, a storage unit 102, an in-vehicle communication unit 103, and so on.

The control unit 101 includes a CPU (Central Processing Unit), a ROM (Read Only Memory), a RAM (Random Access Memory), and so on. The CPU in the control unit 101 controls operations of the aforementioned hardware provided in the in-vehicle device 100 and causes the in-vehicle device 100 to function as a travel assistance device according to the present application by executing a program stored in the ROM or the storage unit 102. The RAM in the control unit 101 temporarily stores various kinds of data that is generated while the program is being executed.

Note that the configuration of the control unit 101 is not limited to the above-described one, and need only be one or more processing circuits that include a single-core CPU, a multi-core CPU, a microcomputer, a volatile or non-volatile memory, or the like. The control unit 101 may also have functions of a clock for outputting date and time information, a timer for measuring an elapsed time since a measurement-start instruction is given until a measurement-end instruction is given, a counter for counting the number, or the like.

The memory 102 includes a non-volatile memory, such as an EEPROM (Electronically Erasable Programmable Read Only Memory). The storage unit 102 stores programs to be executed by the control unit, 101, data required to execute these programs, or the like.

The programs stored in the storage unit 102 may include a travel assistance program for causing the control unit 101 to perform processing to output travel assistance information based on information received from the road-side communicators 200. The control unit 101 realizes a travel assistance method according to this embodiment by executing the travel assistance program.

Note that the programs stored in the storage unit 102 may be provided through a recording medium M that readably stores these programs. The recording medium M is, for example, a portable memory such as a CD-ROM, a USB memory, an SD card, a micro SD card, or a compact flash (registered trademark). The control unit 101 can read various programs from the recording medium M using a reader device (not shown), and install the read various programs in the storage unit 102. Also, the programs to be stored in the storage unit 102 may be provided through communication. For example, a configuration may be employed in which a communication terminal (not shown) capable of communicating with an external server is connected to the in-vehicle communication unit 103, and a program is downloaded from the external server using the communication terminal. In this case, the control unit 101 can fetch the program downloaded using the communication terminal from the in-vehicle communication unit 103, and install the fetched program in the storage unit 102.

The in-vehicle communication unit 103 includes a communication interface for connecting various devices, other ECUs, or the like, via an in-vehicle communication line N. The in-vehicle communication unit 103 communicates with various devices or other ECUs using a communication method conforming to any of various communication standards used in an in-vehicle network, such as a CAN (Controller Area Network), a LIN (Local Interconnect Network), a MOST (Media Oriented Systems Transport), or Ethernet (registered trademark).

In this embodiment, devices connected to the in-vehicle communication unit 103 via the in-vehicle communication line N include a wireless communicator 110, a GPS receiver 120, and a display panel 130.

The wireless communicator 110 includes, for example, a receiving antenna for receiving radio waves in a specific frequency band (e.g. 5.9 GHz band) transmitted from the road-side communicators 200, a receiving module for demodulating the radio waves received by the receiving antenna and outputting a data signal obtained through this demodulation. The wireless communicator 110 transmits the data signal obtained by the receiving module to the in-vehicle device 100 via the in-vehicle communication line N.

Although this embodiment has described a wireless communicator 110 that includes a receiving antenna and a receiving module, the wireless communicator 110 may alternatively include, for example, a transmitting module for modulating a data signal that is to be transmitted, a transmitting antenna for transmitting the data signal that has been modulated by the transmitting module, in the form of radio waves in a specific frequency band. Also, the transmission band used in wireless communication with the road-side communicators 200 is not limited to a 5.9 GHz band, and any appropriate wireless communication method may be used while considering the distance that radio waves can reach, the transmission band, or the like, and different wireless communication methods may be used depending on the situation.

The GPS receiver 120 includes a receiving antenna for receiving a GPS signal, which is transmitted from a GPS satellite (not shown), a computation circuit for measuring the current position of the vehicle C based on the received GPS signal, and so on. The GPS receiver 120 transmits position information regarding the measured current position of the vehicle C to the in-vehicle device 100 via the in-vehicle communication line N.

The display panel 130 includes a liquid-crystal panel, an organic EL panel, or the like. The display panel 130 displays information of which an occupant of the vehicle C is to be notified, based on a signal transmitted from the in-vehicle device 100, for example. Note that the display panel 130 may also include an HMI (Human Machine Interface) for accepting an operation made by the occupant.

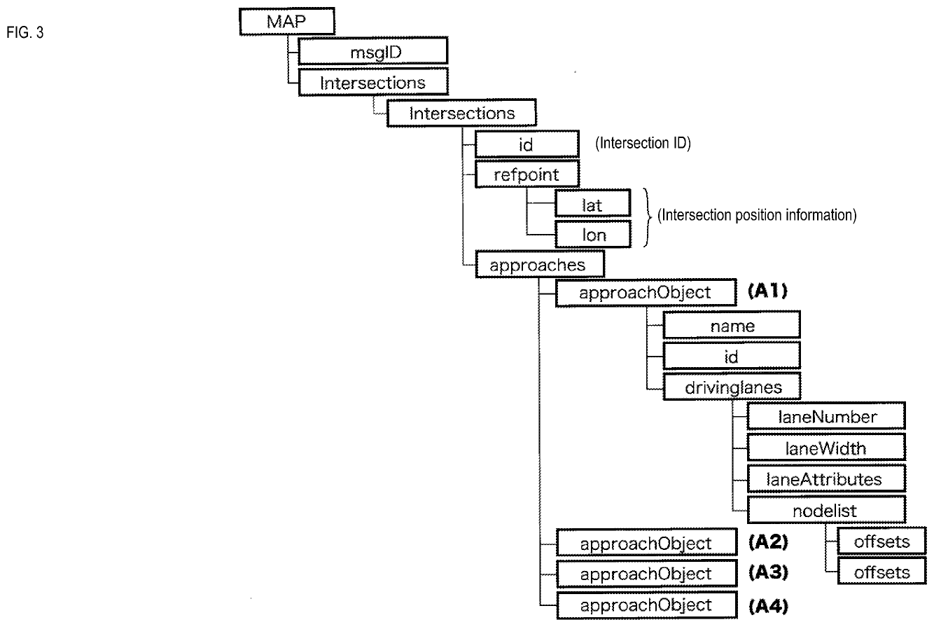

A configuration example of information transmitted by the road-side communicators 200 will be described below. FIG. 3 is a conceptual diagram illustrating a configuration example of intersection information. FIG. 3 shows a configuration example of intersection information (MAP) used in the North American DSRC. The intersection information includes a message ID (msgID), an interchange ID (id), the latitude (lat) and the longitude (lon) that indicate the center coordinates of the intersection, and information regarding approaches (approachObject) to the interchange. The latitude and the longitude that indicate the center coordinates of the intersection correspond to intersection position information. In the example shown in FIG. 3, information regarding four approaches A1 to A4 is included in the intersection information. The approach A1 is an approach to proceed to the intersection from the southern side, for example. In the intersection information, information regarding traffic lanes that constitute the approach A1 (drivinglanes) is described in association with the name (name) and the identifier (id) of the approach A1. Information regarding each traffic lane includes the lane number (laneNumber), the lane width (laneWidth), attributes (laneAttributes), and so on, of the traffic lane. Although the information regarding only one of the traffic lanes constituting the approach A1 is shown due to the spatial limitations of the diagrams, if the approach A1 is constituted by a plurality of traffic lanes, information regarding the respective traffic lanes is described. Although not shown in detail, the same also applies to the other approaches A2 to A4. Note that the intersection information transmitted by the road-side communicators 200 may also be encrypted. If the wireless communicator 110 receives encrypted intersection information, the wireless communicator 110 performs processing to decrypt the received intersection information.

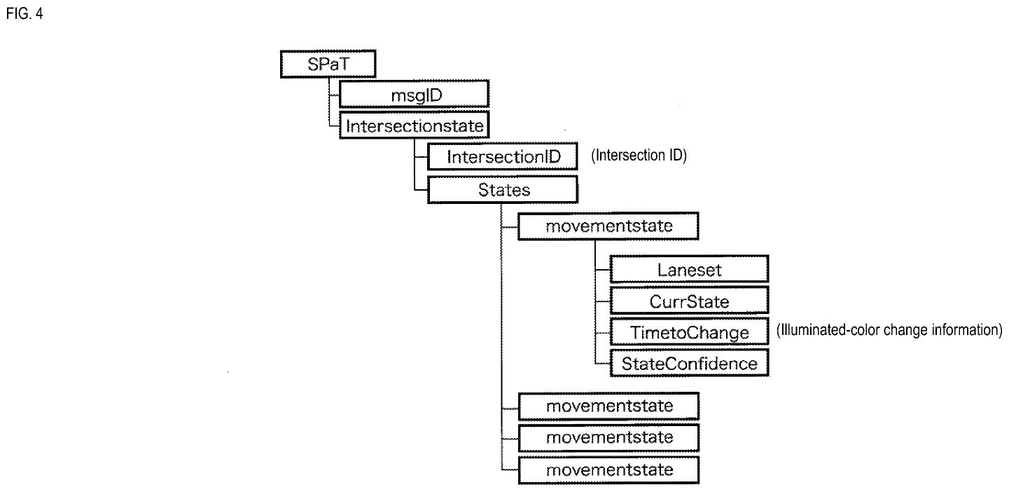

FIG. 4 is a conceptual diagram illustrating a configuration example of traffic signal information. FIG. 4 shows a configuration example of traffic signal information (SPaT) used in the North American DSRC. The traffic signal information includes a message ID (msgID), an intersection ID (IntersectionID), and information indicating the state (movementstate) of a traffic signal installed at the intersection. As the traffic signal information regarding a traffic signal installed at an intersection that is identified by the intersection ID in the intersection information, the same intersection ID as that in the intersection information is used. Information indicating the state of a traffic signal is prepared for each traffic signal, and includes the traffic lane number of a traffic lane in which the traffic signal is installed (Laneset), the color-illumination state of the traffic signal (CurrState), the remaining time until the illuminated color changes from the current color to the next color (TimetoChange), event content reliability (StateConfidence), and so on. Note that the traffic signal information transmitted by the road-side communicators 200 may also be encrypted. If the wireless communicator 110 receives encrypted traffic signal information, the wireless communicator 110 performs processing to decrypt the received traffic signal information.

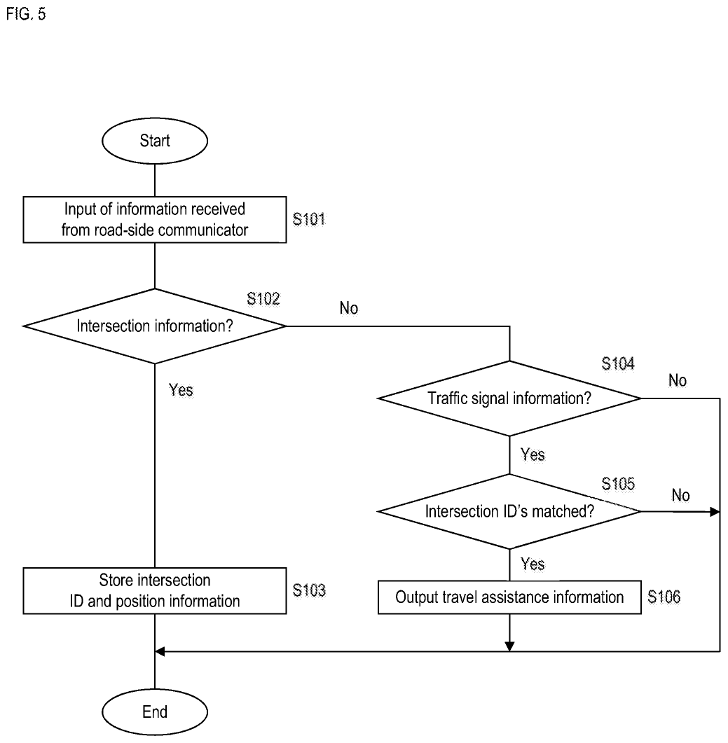

Operations of the in-vehicle device 100 will be described below. FIG. 5 is a flowchart illustrating a processing procedure performed by the in-vehicle device 100 according to Embodiment 1. If the wireless communicator 110 mounted in the vehicle C receives information that is transmitted, as appropriate, from a road-side communicator 200, the wireless communicator 110 transmits the received information to the in-vehicle device 100 via the in-vehicle communication line N. The in-vehicle device 100 receives the information transmitted from the wireless communicator 110, at the in-vehicle communication unit 103. If information from the road-side communicator 200 is input through the in-vehicle communication unit 103 (step S101), the control unit 101 in the in-vehicle device 100 determines whether or not the input information is intersection information (MAP) (step S102).

If it is determined that the input information is the intersection information (S102: YES), the control unit 101 extracts the intersection ID and the intersection position information (latitude and longitude) from the intersection information, and stores the extracted intersection ID and intersection position information in the storage unit 102 (step S103). After storing the intersection ID and the position information in the storage unit 102, the control unit 101 ends the processing of this flowchart.

If it is determined that the input information is not the intersection information (S102: NO), the control unit 101 determines whether or not the input information is traffic signal information (SPaT) (step S104). If it is determined that the input information is not the traffic signal information (S104: NO), the control unit 101 ends the processing of this flowchart.

If it is determined that the input information is the traffic signal information (S104: YES), the control unit 101 determines whether or not the intersection ID included in the input traffic signal information matches an intersection ID in intersection information stored in the storage unit 102 (step S105). If these intersection IDs do not match (S105: NO), that is, if the intersection ID in the input traffic signal information does not match the intersection ID in the intersection information stored in the storage unit 102, or if no intersection ID in intersection information is stored in the storage unit 102, the control unit 101 ends the processing of this flowchart without outputting travel assistance information.

If it is determined that the intersection IDs match (S105: YES), the control unit 101 generates travel assistance information and outputs the generated travel assistance information from the in-vehicle communication unit 103 (step S106). The travel assistance information output from the in-vehicle communication unit 103 is displayed on the display panel 130.

For example, if remaining time until the illuminated color of a traffic signal changes from green to red is included in the received traffic signal information, the control unit 101 can determine, based on the length of the remaining time, whether or not the vehicle C can pass through the next intersection (i.e. the intersection identified by the intersection ID). If it is determined that the vehicle C can pass through the next intersection, the control unit 101 may display a recommended speed on the display panel 130 by generating travel assistance information that includes the recommended speed of the vehicle C and outputting the generated travel assistance information through the in-vehicle communication unit 103.

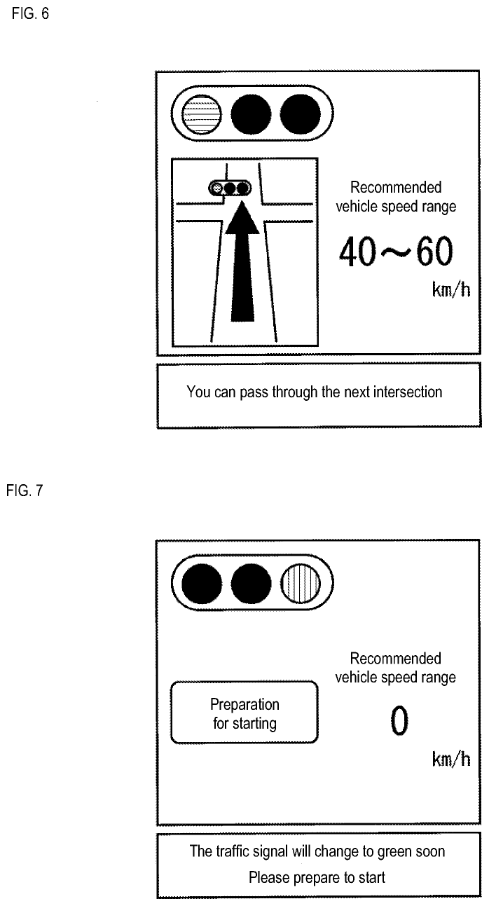

FIG. 6 is a schematic diagram showing a display example of the recommended speed. In the display example in FIG. 6, the facts that the illuminated color of a traffic signal that is installed at the next intersection is green, that the recommended speed is 40 to 60 km/h, and that the vehicle can pass through the next intersection are indicated with schematic diagrams and messages.

If it is determined that the remaining time until the traffic signal changes from green to red is short and the vehicle C cannot pass through the next intersection, the control unit 101 may generate travel assistance information for suggesting that the vehicle C should decelerate or stop, and output the generated travel assistance information through the in-vehicle communication unit 103, thereby display, on the display 130, information for suggesting that the vehicle should decelerate or stop.

If the received traffic signal information includes the remaining time until the illuminated color of the traffic signal changes from red to green, the control unit 101 may generate travel assistance information for suggesting that the vehicle C should keep stopping or prepare to start and output the generated travel assistance information through the in-vehicle communication unit 103, thereby displaying, on the display panel 130, information for suggesting that the vehicle C should keep stopping or prepare to start.

FIG. 7 is a schematic diagram showing a display example in a stopped state. In the display example in FIG. 7, the facts that the illustrated color of a traffic signal installed at an intersection at which the vehicle C is stopping is red, that the illuminated light of the traffic signal will change from red to green after 20 seconds, and that the vehicle C should prepare to start are indicated with a schematic diagram and messages.

If the received traffic signal information includes the remaining time until an arrow signal transitions from an on-state to an off-state, and the vehicle C turns right or left in accordance with the arrow signal, the control unit 101 can determine, based on the length of the remaining time, whether or not the vehicle C can turn right or left at the next intersection. If it is determined that the vehicle C can turn right or left at the next intersection, travel assistance information that includes the recommended speed of the vehicle C may be generated and output through the in-vehicle communication unit 103, thereby displaying the recommended speed on the display panel 130.

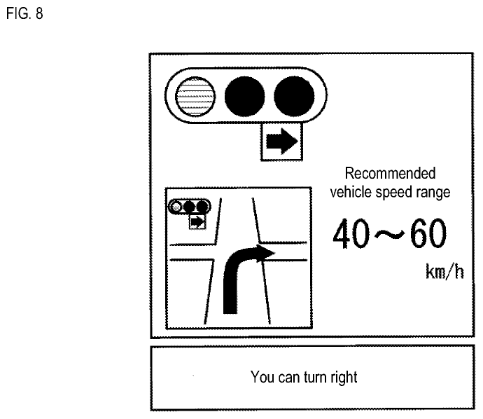

FIG. 8 is a schematic diagram showing a display example when turning right. In the display example in FIG. 8, the facts that an arrow signal of a traffic signal installed at the next intersection is illuminated, that the recommended speed is 40 to 60 km/h, and that the vehicle C can turn right at the next intersection are indicated with schematic diagrams and messages.

As described above, according to this embodiment, if the intersection ID included in intersection information matches the intersection ID included in traffic signal information, travel assistance for the vehicle C can be performed for the driver thereof by outputting travel assistance information that is based on the traffic signal information. On the other hand, if traffic signal information is received at a timing at which traffic signal information with a matched intersection ID has not been received, travel assistance information that is based on this traffic signal information is not output. Accordingly, when the vehicle passes through an intersection, travel assistance being performed based on traffic signal information regarding a traffic signal installed at another intersection is avoided.

Embodiment 1 employs a configuration in which the intersection ID included in intersection information is compared with the intersection ID included in traffic signal information, and travel assistance information is output if these intersection IDs match. However, a configuration may alternatively be employed in which a positional relationship between the vehicle C and an intersection is specified based on position information regarding the vehicle (vehicle C) and position information regarding the intersection, and the control unit 101 determines, based on the specified positional relationship, whether or not to allow travel assistance information to be output. That is to say, the control unit 101 may also function as a determination unit for determining whether or not to allow travel assistance information to be output.

In Embodiments 2 to 4, which will be described below, whether or not to allow travel assistance information to be output is determined based on a positional relationship between a vehicle (vehicle C) and an intersection, and travel assistance information is output if it is determined that travel assistance information is allowed to be output, thereby performing travel assistance.

### Embodiment 2

Embodiment 2 will describe a configuration in which travel assistance is not performed if another intersection is present between an intersection for which travel assistance is to be performed and the vehicle, and travel assistance information is output to perform travel assistance if no other intersection is present. Note that the entire configuration of the travel assistance system and the internal configuration of the in-vehicle device 100 are the same as those in Embodiment 1, and a description thereof is omitted accordingly.

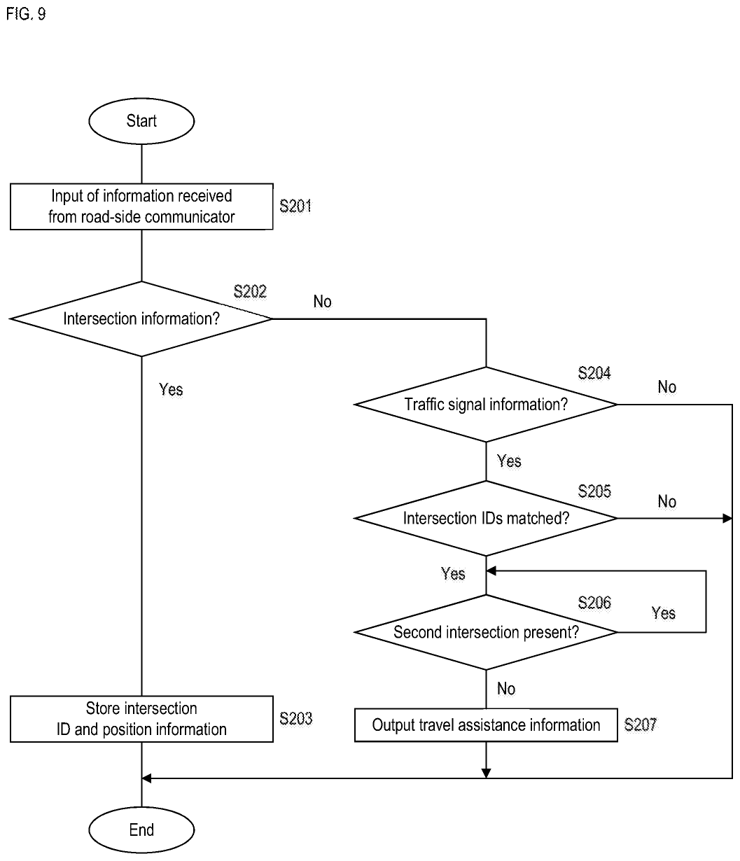

FIG. 9 is a flowchart illustrating a processing procedure performed by the in-vehicle device 100 according to Embodiment 2. The information from a road-side communicator 200 is input through the in-vehicle communication unit 103 (step S201), the control unit 101 in the in-vehicle device 100 determines whether or not the input information is intersection information (MAP) (step S202).

If it is determined that the input information is intersection information (S202: YES), the control unit 101 extracts the intersection ID and intersection position information (latitude and longitude) from the intersection information, and stores the extracted intersection ID and intersection position information in the storage unit 102 (step S203). After storing the intersection ID and the position information in the storage unit 102, the control unit 101 ends the processing of this flowchart.

If it is determined that the input information is not intersection information (S202: NO), the control unit 101 determines whether or not the input information is traffic signal information (SPaT) (step S204). If it is determined that the input information is not traffic signal information (S204: NO), the control unit 101 ends the processing of this flowchart.

If it is determined that the input information is traffic signal information (S204: YES), the control unit 101 determines whether or not the intersection ID included in the input traffic signal information matches the intersection ID in intersection information stored in the storage unit 102 (step S205). If it is determined that these intersection IDs do not match (S205: NO), i.e. if the intersection ID in the input traffic signal information does not match the intersection ID in the intersection information stored in the storage unit 102, or if no intersection ID in intersection information is stored in the storage unit 102, the control unit 101 ends the processing of this flowchart without outputting travel assistance information.

If it is determined that the intersection IDs match (S205: YES), the control unit 101 determines whether or not another intersection (second intersection) is present between the intersection (first intersection) identified by this intersection ID and the vehicle (step S206). The control unit 101 can determine whether or not the second intersection is present between the position of the first intersection and the position of the vehicle specified through the GPS receiver 120, by referencing the intersection position information stored in the storage unit 102. Note that the second intersection does not need to be present on a straight line that connects the position of the first intersection to the position of the vehicle, and it may be determined whether or not the second intersection is present within a rectangular region with a line that connects the position of the first intersection to the position of the vehicle serving as a diagonal, or within a circular region with the aforementioned line serving as a diameter.

If it is determined that another intersection is present (S206: YES), the control unit 101 again performs the processing in step S206. At this time, the control unit 101 may be configured to again perform the processing in step S206 after a set period has elapsed. If the vehicle C is traveling, the positional relationship between the vehicle C and each intersection changes sequentially. Thus, in the determination in step S206 performed after the vehicle C has passed through the second intersection, it may be determined that the second intersection is not present between the first intersection and the vehicle.

If it is determined that there is no other intersection (S206: NO), the control unit 101 generates travel assistance information and outputs the generated travel assistance information from the in-vehicle communication unit 103 (step S207). The travel assistance information output from the in-vehicle communication unit 103 is displayed on the display panel 130.

In this embodiment, the control unit 101 can specify the position of the vehicle C and the position of an intersection through which the vehicle C is about to pass, and thus can estimate the traveling time it will take until the vehicle C reaches the intersection by acquiring vehicle speed information from a vehicle speed sensor, which is not shown in the diagrams. Accordingly, if the changing time it will take until the illuminated color of a traffic signal changes from green to red is included in the received traffic signal information, the control unit 101 can determine whether or not the vehicle C will pass through the intersection based on the traveling time it will take until the vehicle C reaches the intersection and the length of the changing time it will take until the illuminated color of the traffic signal changes from green to read. In step S207, the control unit 101 may generate travel assistance information based on the determination result that is based on the aforementioned traveling time and the changing time, and output the generated travel assistance information from the in-vehicle communication unit 103.

As described above, according to Embodiment 2, even if the intersection ID included in intersection information matches the intersection ID included in traffic signal information, if another intersection (second intersection) is present between an intersection (first intersection) identified by this intersection ID and the vehicle, travel assistance information is not output. Accordingly, when the vehicle passes through an intersection, travel assistance being performed based on traffic signal information regarding a traffic signal installed at another intersection is avoided.

### Embodiment 3

Embodiment 3 will describe a configuration in which, if the in-vehicle device 100 receives a plurality of pieces of intersection information, travel assistance is performed based on traffic signal information regarding the intersection that is closest to the vehicle (vehicle C).

Note that the entire configuration of the travel assistance system and the internal configuration of the in-vehicle device 100 are the same as those in Embodiment 1, and descriptions thereof are omitted accordingly.

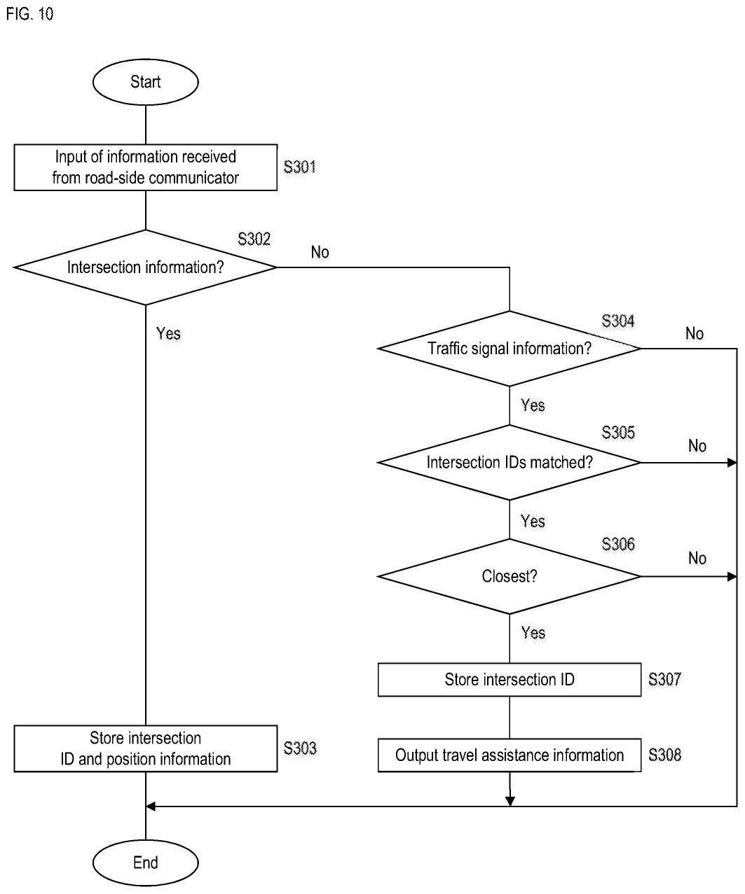

FIG. 10 is a flowchart illustrating a processing procedure performed by the in-vehicle device 100 according to Embodiment 3. If information from a road-side communicator 200 is input through the in-vehicle communication unit 103 (step S301), the control unit 101 in the in-vehicle device 100 determines whether or not the input information is intersection information (MAP) (step S302).

If it is determined that the input information is intersection information (S302: YES), the control unit 101 extracts the intersection ID and intersection position information (latitude and longitude) from the intersection information, and stores the extracted intersection ID and intersection position information in the storage unit 102 (step S303). After storing the intersection ID and the position information in the storage unit 102, the control unit 101 ends the processing of this flowchart.

If it is determined that the input information is not intersection information (S302: NO), the control unit 101 determines whether or not the input information is traffic signal information (SPaT) (step S304). If it is determined that the input information is not traffic signal information (S304: NO), the control unit 101 ends the processing of this flowchart.

If it is determined that the input information is traffic signal information (S304: YES), the control unit 101 determines whether or not the intersection ID included in the input traffic signal information matches the intersection ID in the intersection information stored in the storage unit 102 (step S305). If it is determined that these intersection IDs do not match (S305: NO), i.e. if the intersection ID in the input traffic signal information does not match the intersection ID in intersection information stored in the storage unit 102, or if no intersection ID in intersection information is stored in the storage unit 102 the control unit 101 ends the processing of this flowchart without outputting travel assistance information.

If it is determined that the intersection IDs match (S305: YES), the control unit 101 determines whether or not the intersection identified by this intersection ID is closest to the vehicle (step S306). The control unit 101 can calculate the distance from the vehicle to each intersection based on the corresponding intersection position information stored in the storage unit 102 and the vehicle position information input from the GPS receiver 120. The control unit 101 can determine, based on the calculated distance, whether or not the intersection identified by the matched intersection ID is closest to the vehicle.

If another intersection is closest to the vehicle (S306: NO), the control unit 101 ends the processing of this flowchart.

If it is determined that the intersection identified by the matched intersection ID is closest to the vehicle (S306: YES), the control unit 101 stores this intersection ID as the intersection ID of an intersection for which travel assistance is to be performed, in the storage unit 102 (step S307).

Next, the control unit 101 generates travel assistance information based on traffic signal information that includes the intersection ID for which travel assistance is to be performed, and outputs the generated travel assistance information from the in-vehicle communication unit 103 (step S308). The travel assistance information output from the in-vehicle communication unit 103 is displayed on the display panel 130.

As described above, according to Embodiment 3, travel assistance can be performed based on traffic signal information from a road-side communicator 200 installed at the intersection that is closest to the vehicle C. On the other hand, if traffic signal information transmitted from a road-side communicator 200, which is farther away, is received, then travel assistance is not performed based on this traffic signal information. Accordingly, when the vehicle passes through an intersection, travel assistance being performed based on traffic signal information regarding a traffic signal that is installed at another intersection is avoided.

### Embodiment 4

Embodiment 4 will describe a configuration in which travel assistance is performed based on traffic signal information regarding an intersection that is present in the direction in which the vehicle (vehicle C) proceeds.

Note that the entire configuration of the travel assistance system and the internal configuration of the in-vehicle device 100 are the same as those in Embodiment 1, and a description thereof is omitted accordingly.

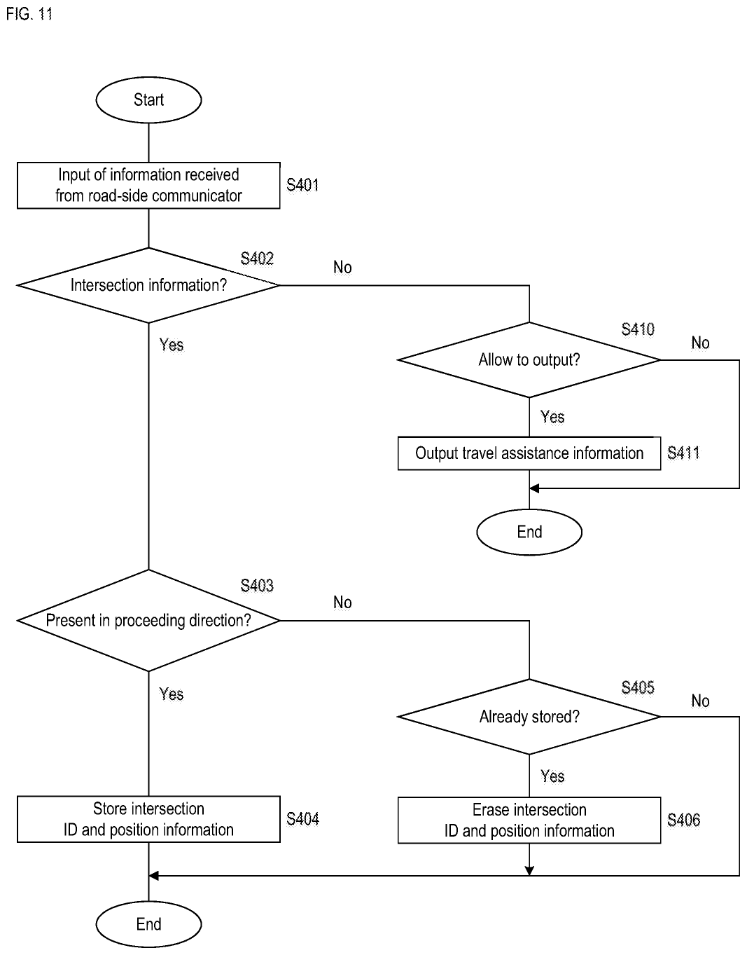

FIG. 11 is a flowchart illustrating a processing procedure performed by the in-vehicle device 100 according to Embodiment 4. If information from a road-side communicator 200 is input through the in-vehicle communication unit 103 (step S401), the control unit 101 in the in-vehicle device 100 determines whether or not the input information is intersection information (MAP) (step S402).

If it is determined that the input information is intersection information (S402: YES), the control unit 101 determines whether or not this intersection information is from a road-side communicator 200 that is present in the direction in which the vehicle C proceeds (step S403). The control unit 101 can use a known method to specify the direction in which the vehicle C proceeds. For example, the control unit 101 can specify the direction in which the vehicle C proceeds by storing, in the storage unit 102, position information regarding the vehicle C that is input from the GPS receiver 120, and obtaining a difference between the position information regarding the vehicle C stored in the storage unit 102 and the position information regarding the vehicle C that is specified by the GPS receiver 120. The control unit 101 determines whether or not the road-side communicator 200 installed at the intersection is present in the direction in which the vehicle C proceeds, based on the specified direction in which the vehicle C proceeds and the intersection position information included in the received intersection information.

If it is determined that the intersection information is from a road-side communicator 200 that is present in the direction in which the vehicle C proceeds (step S403: YES), the control unit 101 extracts the intersection ID and intersection position information (latitude and longitude) from the input intersection information, and stores the extracted intersection ID and intersection position information in the storage unit 102 (step S404). After storing the intersection ID and the position information in the storage unit 102, the control unit 101 ends the processing of this flowchart.

If it is determined that intersection information is from a road-side communicator 200 that is not present in the direction in which the vehicle C proceeds (S403: NO), the control unit 101 determines whether or not this intersection information is stored in the storage unit 102 (step S405).

If it is determined that this intersection information is stored in the storage unit 102 (S405: YES), the control unit 101 erases the intersection information that is stored according to the determination from the storage unit 102 (step S406). On the other hand, if it is determined that this intersection information is not stored in the storage unit 102 (S405: NO), the control unit 101 ends the processing of this flowchart.

If, in step S402, it is determined that the input information is not intersection information (S402: NO), the control unit 101 determines whether or not to allow travel assistance information to be output (step S410) in accordance with the same procedure as that in Embodiments 1 to 3. If it is determined that travel assistance information is allowed to be output (S410: YES), the control unit 101 outputs travel assistance information (step S411). If it is determined that travel assistance information is not allowed to be output (S410: NO), the control unit 101 ends the processing of this flowchart without outputting travel assistance information.

As described above, according to Embodiment 4, intersection information that is received from a direction other than the direction in which the vehicle C proceeds is erased. Thus, even if traffic signal information is received from a direction other than the proceeding direction, travel assistance is not performed based on this traffic signal information. As a result, when the vehicle passes through an intersection, travel assistance being performed based on traffic signal information regarding a traffic signal that is installed at another intersection is avoided.

The embodiments disclosed herein are examples in all aspects, and should be considered to be not restrictive. The scope of the present disclosure is indicated not by the above-described meanings but by the claims, and is intended to include all modifications within the meanings and scope equivalent to the claims.

What is claimed is:

1. A travel assistance device to be mounted in a vehicle, the device comprising:
an in-vehicle communication unit to which information received from a road-side communicator is input; and
an output unit configured to, if both intersection information including an identifier identifying an intersection and position information regarding the intersection and traffic signal information including the same identifier are input from the in-vehicle communication unit, output travel assistance information that is based on the traffic signal information.

2. The travel assistance device according to claim 1, further comprising:
a determination unit configured to, if position information regarding the vehicle is input from the in-vehicle communication unit, specify a positional relationship between the vehicle and an intersection based on the position information regarding the vehicle and the intersection information, and determine, based on the specified positional relationship, whether or not to allow the travel assistance information to be output,
wherein the output unit outputs the travel assistance information if the determination unit determines that the travel assistance information is allowed to be output.

3. The travel assistance device according to claim 2,
wherein if a plurality of pieces of intersection information are input from the in-vehicle communication unit, the determination unit determines whether or not a second intersection is present between a first intersection and the vehicle, and if it is determined that the second intersection is present, the determination unit determines that the travel assistance information that is based on traffic signal information including the same identifier as an identifier of the first intersection is not allowed to be output.

4. The travel assistance device according to claim 2,
wherein if a plurality of pieces of intersection information are input from the in-vehicle communication unit, the determination unit specifies an intersection that is closest to the vehicle, and determines that travel assistance information that is based on traffic signal information including an identifier different from an identifier of the specified intersection is not allowed to be output.

5. The travel assistance device according to claim 2, wherein if an intersection identified by the intersection information is not present in a direction in which the vehicle proceeds, the determination unit determines that travel assistance information that is based on traffic signal information including the same identifier as an identifier of the intersection is not allowed to be output.

6. The travel assistance device according to claim 2, further comprising:
a storage unit configured to store intersection information input from the in-vehicle communication unit; and
an erasing unit configured to erase, from the storage unit, intersection information regarding an intersection that is not present in a direction in which the vehicle proceeds, out of the intersection information stored in the storage unit.

7. A travel assistance method for assisting traveling of a vehicle, the method comprising:
outputting travel assistance information that is based on traffic signal information if both intersection information including an identifier identifying an intersection and position information regarding the intersection and the traffic signal information including the same identifier are input.

8. A computer program for causing a computer mounted in a vehicle to perform processing for:
outputting travel assistance information that is based on traffic signal information if both intersection information including an identifier identifying an intersection and position information regarding the intersection and the traffic signal information including the same identifier are input.

9. The travel assistance device according to claim 3, wherein if an intersection identified by the intersection information is not present in a direction in which the vehicle proceeds, the determination unit determines that travel assistance information that is based on traffic signal information including the same identifier as an identifier of the intersection is not allowed to be output.

10. The travel assistance device according to claim 4, wherein if an intersection identified by the intersection information is not present in a direction in which the vehicle proceeds, the determination unit determines that travel assistance information that is based on traffic signal information including the same identifier as an identifier of the intersection is not allowed to be output.

11. The travel assistance device according to claim 3, further comprising:
a storage unit configured to store intersection information input from the in-vehicle communication unit; and
an erasing unit configured to erase, from the storage unit, intersection information regarding an intersection that is not present in a direction in which the vehicle proceeds, out of the intersection information stored in the storage unit.

12. The travel assistance device according to claim 4, further comprising:
a storage unit configured to store intersection information input from the in-vehicle communication unit; and
an erasing unit configured to erase, from the storage unit, intersection information regarding an intersection that is not present in a direction in which the vehicle proceeds, out of the intersection information stored in the storage unit.

13. The travel assistance device according to claim 5, further comprising:
a storage unit configured to store intersection information input from the in-vehicle communication unit; and
an erasing unit configured to erase, from the storage unit, intersection information regarding an intersection that is not present in a direction in which the vehicle proceeds, out of the intersection information stored in the storage unit.
